(19) United States
(12) Patent Application Publication
(10) Pub. No.: US 2013/0343284 A1
(43) Pub. Date: Dec. 26, 2013

(54) METHOD FOR MEMBERS OF EMERGENCY RESCUE GROUP UTILIZING RADIOS TO TRANSMIT COMPOUND FILES CONTAINING COMPRESSED PHOTO/TEXT/VOICE DATA OF AN EMERGENCY EVENT SITE DIRECTLY OR THROUGH SIGNAL REPEATER TO CONSOLE FOR REAPPEARANCE OF THE EVENT SITE

(71) Applicant: UNICATION GROUP/Unication Co., Ltd., New Taipei City (TW)

(72) Inventor: SHIH-TSENG YEH, New Taipei City (TW)

(73) Assignee: UNICATION GROUP/Unication Co., Ltd., New Taipei City (TW)

(21) Appl. No.: 14/010,494

(22) Filed: Aug. 26, 2013

Related U.S. Application Data
(63) Continuation-in-part of application No. 13/238,259, filed on Sep. 21, 2011, now abandoned.

(30) Foreign Application Priority Data
Sep. 29, 2010 (TW) 099133192

(51) Int. Cl. H04W 4/22

(52) U.S. Cl. CPC H04W 4/22
USPC 370/328

(57) ABSTRACT

A method for members of an emergency rescue group utilizing radios to transmit compound files containing compressed photo/text/voice data of an emergency event site directly or through a signal repeater to a console for reappearance of the event site, includes: the radio capable of creating a compound file containing pictures of the emergency event site, GPS coordinates of where the pictures are taken, and a voice description of an on-site situation or the photos, and transmitting the compound file over an existing channel directly or through a signal repeater to the console at a rescue center, so as to allow the console receiving the compound file to reappear a real situation of the event site and to improve the efficiency of dispatching and commanding personnel, medical or material resources conducted by public security rescue units or military units.

### CROSS-REFERENCE TO RELATED APPLICATION

This application is a continuation-in-part of U.S. patent application Ser. No. 13/238,259, filed Sep. 21, 2011, priority of the filing date of which is hereby claimed under 35 U.S.C. §120.

### BACKGROUND OF THE INVENTION

1. Field of the Invention

The present invention relates to a method for members of an emergency rescue group utilizing radios to transmit compound files containing compressed photo/text/voice data of an emergency event site directly or through a signal repeater to a console for reappearance of the event site, and more particular to a method for utilizing a mobile radio (low power) or a vehicle-carried radio (high power) to transmit real-time pictures of the event site, GPS coordinates of where the pictures are taken, and a voice description of an on-site situation or the photos, which are incorporated by a technique of creating a compound file containing compressed photo/text/voice data, directly or through a signal repeater at a bandwidth of 6.25 KHz/12.5 KHz/25 KHz within a radio communication frequency range of 1 MHz to 1 GHz to the console (computer or radio) at a rescue center for reappearance of the real situation of the event site.

2. Related Art

A traditional emergency rescue radio communication system used by service units, such as, police, fire brigade, medical services, rescue operations and military forces, includes at least a center console and a plurality of radios (e.g. two-way radios). The radio is often carried by members on duty for two-way voice communication or data transmission with the console or other members over an existing radio frequency (RF) channel. Moreover, the traditional radio system cannot report information about an on-site picture of the emergency event, voice description of the event, and event location to the console or/and other radios over an existing RF channel. As a result, the rescue members are not able to rapidly and completely report the first hand information about the emergency event site to the console or other radios, whereby lower the efficiency of the emergency rescue system.

For instance, when carrying out an operation in a site of an earthquake or a flood of which the situation is too complicated to describe, and the rescue members is not able to instantaneously efficiently report the first hand information (e.g. extent of the disaster, the collapse of roadbed, flood destruction of bridges, floods) in detail about one or multiple disaster sites to the console or a commander of the rescue center, it is difficult for the rescue center to duly provide dispatch and support of useful personnel, food, traffic or other rescue equipment that results in the delay in the best timing for rescue, and may leads to a further bigger disaster.

### SUMMARY OF THE INVENTION

In respect of a radio communication for an emergency rescue group, it is imperative to provide a method for transmitting comprehensive information where a radio is capable of creating a compound file containing the first hand information about pictures of a disaster site, global positioning system (GPS) coordinates of the event site, and a voice description of an on-site situation of the event site or the photos, and then transmitting the compound file over an existing channel directly or through a signal repeater to the console or/and other radios, so as to enable the console or/and the other radios, upon receipt of the compound file, to simultaneously view and listen to the on-site situation of the emergency event site, and to obtain the GPS coordinates of the emergency event site, whereby helping people who receive the message efficiently work on each rescue mission or dispatch.

Accordingly, an object of the present invention is to provide a method for members of an emergency rescue group utilizing radios to transmit compound files containing compressed photo/text/voice data of an emergency event site directly or through a signal repeater to a console for reappearance of the event site, comprising: a. utilizing the radio to obtain photos of the emergency event site and store the photos in a memory; b. utilizing a technique of creating a compound file containing compressed photo/text/voice data for combining the photos being obtained with global positioning system (GPS) coordinates of the emergency event site and a voice description of an on-site situation of the event site or the photos so as to create a message in compound file format; c. transmitting the message in compound file format to the console or/and other radios over an existing radio frequency (RF) channel directly or through an existing signal repeater; and d. the console or/and users of the other radios receiving the message in compound file format being capable of viewing the photos of the event site on a display screen of the radio, listening to the voice description of the on-site situation of the event site, and locating a position of the emergency event site from a GPS positioning map displayed on the display screen. In this manner, the signal recipient can readily reappear the real situation of the event site so as to improve the efficiency of dispatching and commanding personnel, medical or material resources.

### BRIEF DESCRIPTION OF THE DRAWINGS

FIG. 1 is a schematic disposition of a radio system in accordance with a method of an embodiment of the present invention.

FIG. 2 is a block diagram showing a circuit of a radio of the present invention.

FIG. 3 is a flow chart of performing a method of the present invention.

### DESCRIPTION OF THE PREFERRED EMBODIMENTS

For better and further knowledge and understanding of the method and efficacy of the present invention, embodiments are hereby given with detailed descriptions in cooperation with the attached drawings below.

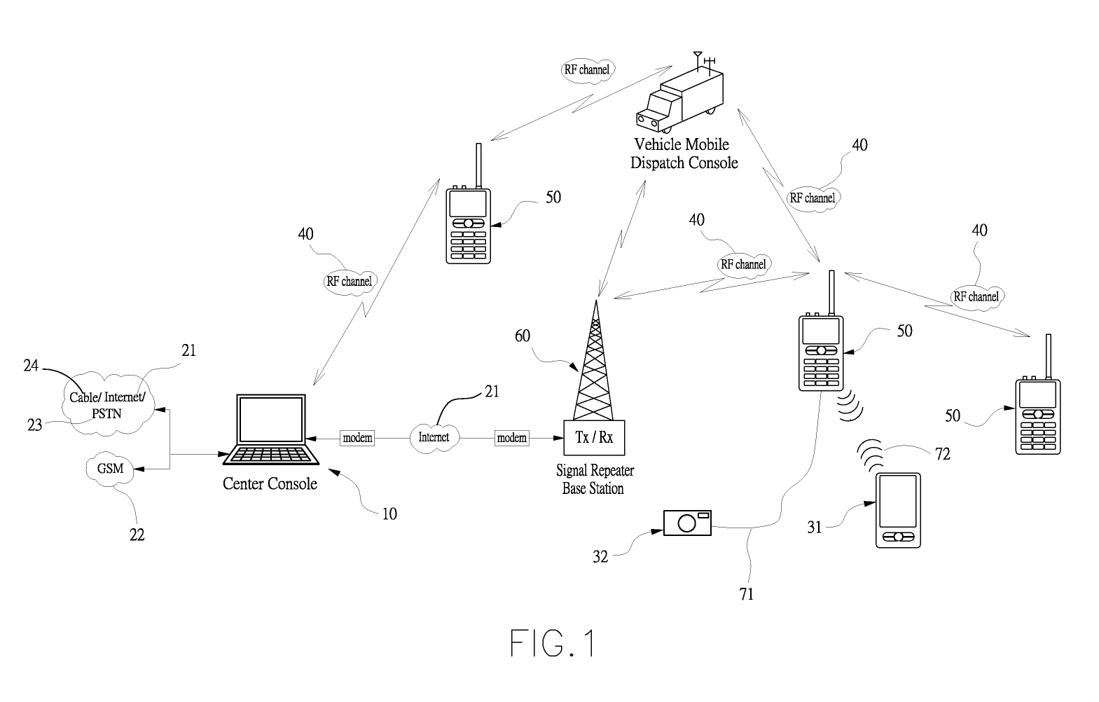

Referring to FIG. 1, a radio communication system for an emergency rescue group at least comprises a console 10, a signal repeater 60, and multiple radios 50. The console 10 is intended to transmit a dispatch message over an existing radio frequency (RF) channel 40 to members of the rescue group, and to receive messages of emergency events reported from or requests from members of the members; the console 10 is also intended to receive emergency event messages from other rescue units through one of Internet 21, global system for mobile communications (GSM) 22, public switched telephone network (PSTN) 23, and electric cables 24. Each of the radios 50 is capable of communicating with the console 10 or/and other radios 50 of the group through the signal repeater 60, and each radio 50 further comprises a global positioning system (GPS) receiving module (not shown) for receiving GPS satellite positioning coordinates data. The signal repeater 60 is intended to extend a communication range (distance) between the console 10 and the radio 50, or among the multiple radios 50. The console 10, the radio 50, and the signal repeater 60 are in communication with each other on an existing RF channel to receive/transmit text/voice messages or other information at a bandwidth of 6.25 KHz/12.5 KHz/25 KHz within a communication frequency range of 1 MHz to 1 GHz.

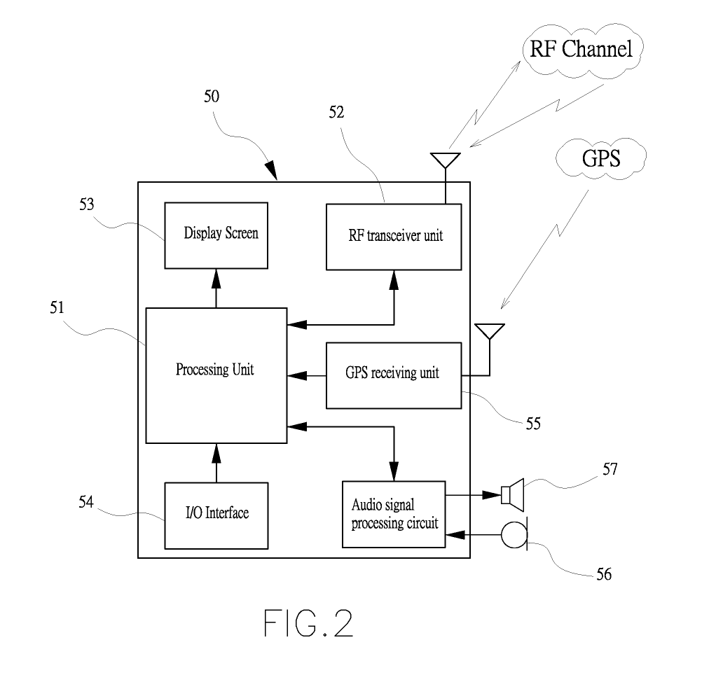

Referring to FIG. 2, the radio 50 at least comprises a processing unit 51, a RF transceiver unit 52, a display screen 53, an I/O interface 54, a GPS receiving unit 55, and a microphone 56 and a speaker 57 of an audio processing circuit. The processing unit 51 is a major component that is coupled with each of the above mentioned elements of the radio 50 for controlling and executing voice communication and data transmission. The I/O interface 54 is intended to receive/transmit text/voice/photo data. The GPS receiving unit 55 is intended to receive GPS coordinate signals of a current position of the radio 50.

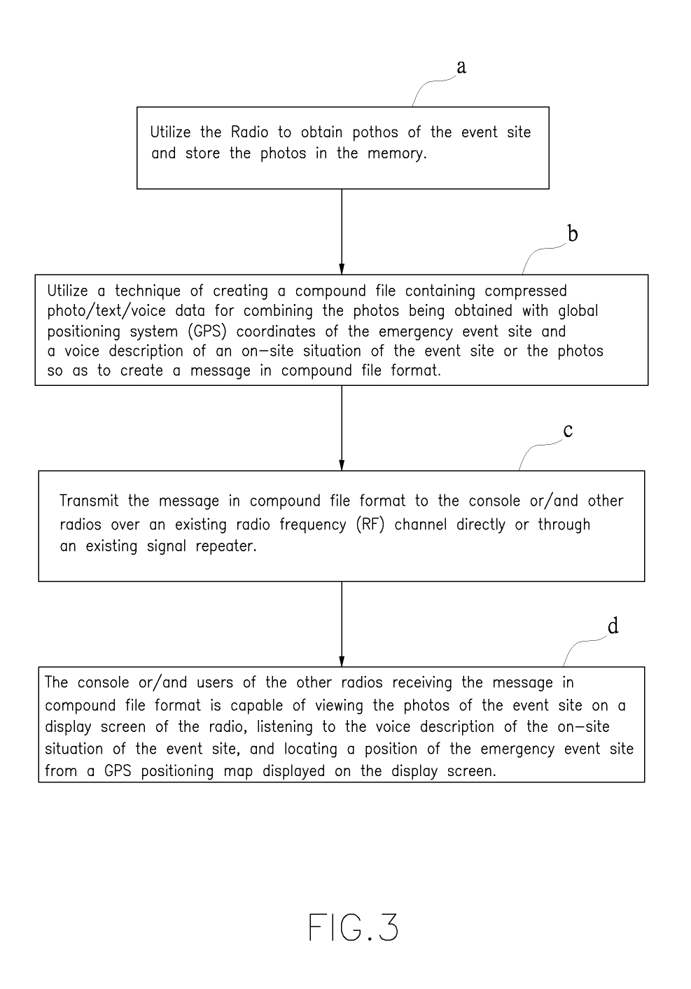

Further referring to FIG. 3 for the radio system and the radio, the members of the emergency rescue group is able to perform the method of the present invention by utilizing the radio 50 to transmit compound files containing compressed photo/text/voice data of an emergency event site directly or through the signal repeater 60 to the console 10 for reappearance of the event site. The method of the present invention comprises:
a. utilizing the radio 50 to obtain photos (images) of the emergency event site and store the photos in a memory;
b. when viewing the photos being obtained on the radio 50, a user of the radio 50 is capable of utilizing a technique of creating a compound file containing compressed photo/text/voice data for combining the photos being obtained with GPS coordinates of the emergency event site and a voice description of an on-site situation of the event site or the photos so as to create a message in compound file format; the voice description being made by the user who conducts a real-time record from the microphone 56 of the radio 50;
c. the radio 50 being capable of transmitting the message in compound file format to the console 10 or/and the other radios 50 over the existing RF channel directly (in direct call mode) or through the existing signal repeater 60 of the system at the bandwidth of 6.25 KHz/12.5 KHz/25 KHz within the communication frequency range of 1 MHz to 1 GHz; and
d. the console 10 or/and users of the other radios 50 receiving the message in compound file format being capable of viewing the photos of the event site on the display screen 53 of the radio 50, simultaneously playing the voice description of the on-site situation or the photos through the speaker 57 of the console 10 or/and the radio 50, and locating a position of the emergency event site from a positioning map displayed on the display screen 53 based on a built-in GPS function.

As the method described above, the radio system is one of an analog system and a digital system; the radio 50 further has a picturing function, or is capable of receiving photos or images from 3G/4G cell phones 31, digital cameras 32 or other film recording equipment. The photo or image data is capable of being transmitted over the I/O interface 54 to the processing unit 51 of the radio 50 through a signal cable 71 or a Bluetooth transmission system 72.

The control 10 is one of a stationary console and a mobile console, wherein the stationary console is linked with the signal repeater 60 through Internet 21 to retransmit/receive messages by the signal repeater 60, and the mobile console is directly linked with the radio 50 or the signal repeater 60 through the existing RF channel.

After the user select a target and a message in compound file format on the display screen 53 of the radio 50 to be transmitted to the target, the compound file containing the data of the on-site photos, the GPS coordinates, and the voice description is being modulated on the existing RF channel by the processing unit 51 of the radio 50. The message in compound file format is being transmitted to the RF transceiver unit 52 and then is sent out on the RF channel.

Furthermore, after the console 10 receives the message in compound file format from the radio 50, the console 10 is capable of designating one or multiple members of the members to transmit a dispatch message directly or through the signal repeater 60 for dispatching and commanding. The dispatch message further comprises the message in compound file format containing the photos, the GPS coordinates, and the voice description that is previously received by the console 10 in order for instantaneously reappearance of the on-site situation for each member of the members being dispatched, whereby to benefit follow-up rescue work.

It is understood that the invention may be embodied in other forms within the scope of the claims. Thus the present examples and embodiments are to be considered in all respects as illustrative, and not restrictive, of the invention defined by the claims

What is claimed is:

1. A method for members of an emergency rescue group utilizing radios to transmit compound files containing compressed photo/text/voice data of an emergency event site directly or through a signal repeater to a console for reappearance of the event site, comprising:
a. utilizing the radio to obtain photos of the emergency event site and store the photos in a memory;
b. utilizing a technique of creating a compound file containing compressed photo/text/voice data for combining the photos being obtained with global positioning system (GPS) coordinates of the emergency event site and a voice description of an on-site situation of the event site or the photos so as to create a message in compound file format;
c. transmitting the message in compound file format to the console or/and other radios over an existing radio frequency (RF) channel directly or through an existing signal repeater; and
d. the console or/and users of the other radios receiving the message in compound file format being capable of viewing the photos of the event site on a display screen of the radio, listening to the voice description of the on-site situation of the event site, and locating a position of the emergency event site from a GPS positioning map displayed on the display screen.

2. The method of claim 1, wherein the console is one of a stationary console and a mobile console, the stationary console linked with the signal repeater through Internet to retransmit/receive messages by the signal repeater, and the mobile console being directly linked with the radio or the signal repeater through an existing RF channel.

3. The method of claim 1, wherein the compound file containing the data of the on-site photos, the GPS coordinates, and the voice description is being modulated on the existing RF channel of the radio so as to be transmitted as the message in compound file format through a RF transceiver unit.

4. The method of claim 1, wherein after the console receives the message in compound file format from the radio, the console is capable of designating one or multiple members of the members to transmit a dispatch message through the signal repeater, wherein the dispatch message further comprises the message in compound file format previously received by the console.

5. A method for members of an emergency rescue group utilizing radios to transmit compound files containing compressed photo/text/voice data of an emergency event site directly or through a signal repeater to a console for reappearance of the event site, comprising:
a. utilizing the radio to obtain photos of the emergency event site and store the photos in a memory;
b. utilizing a technique of creating a compound file containing compressed photo/text/voice data for combining the photos being obtained with global positioning system (GPS) coordinates of the emergency event site and a voice description of an on-site situation of the event site or the photos so as to create a message in compound file format;
c. transmitting the message in compound file format to the console or/and other radios over an existing radio frequency (RF) channel directly or through an existing signal repeater, wherein the existing RF channel is at a bandwidth of 6.25 KHz/12.5 KHz/25 KHz within a communication frequency range of 1 MHz to 1 GHz; and
d. the console or/and users of the other radios receiving the message in compound file format being capable of viewing the photos of the event site on a display screen of the radio, listening to the voice description of the on-site situation of the event site, and locating a position of the emergency event site from a GPS positioning map displayed on the display screen.

6. The method of claim 5, wherein the console is one of a stationary console and a mobile console, the stationary console linked with the signal repeater through Internet to retransmit/receive messages by the signal repeater, and the mobile console being directly linked with the radio or the signal repeater through an existing RF channel.

7. The method of claim 5, wherein the compound file containing the data of the on-site photos, the GPS coordinates, and the voice description is being modulated on the existing RF channel of the radio so as to be transmitted as the message in compound file format through a RF transceiver unit.

8. The method of claim 5, wherein after the console receives the message in compound file format from the radio, the console is capable of designating one or multiple members of the members to transmit a dispatch message through the signal repeater, wherein the dispatch message further comprises the message in compound file format previously received by the console.
